(19) United States
(12) Patent Application Publication
(10) Pub. No.: US 2017/0145527 A1
(43) Pub. Date: May 25, 2017

(54) System and Method for Forming Spherical Silica-Based Proppant and Pig Iron Utilizing Mining Slag

(71) Applicant: Premier Industries, LLC, Dallas, TX (US)

(72) Inventors: Richard Tabish, Missoula, MT (US); Daniel A. Tabish, Missoula, MT (US); Courtney Young, Butte, MT (US); Lane McNamara, Plano, TX (US)

(73) Assignee: Premier Industries, LLC, Dallas, TX (US)

(21) Appl. No.: 15/359,375

(22) Filed: Nov. 22, 2016

Related U.S. Application Data
(60) Provisional application No. 62/259,545, filed on Nov. 24, 2015.

(51) Int. Cl. C21B 3/06; C09K 8/80; B22D 3/00; C01B 33/18; C21B 3/02; C21B 11/08

(52) U.S. Cl. CPC C21B 3/06; C21B 3/02; C21B 11/08; B22D 3/00; C01B 33/181; C09K 8/80

(57) ABSTRACT

Pig iron and spherical silica-based proppant are extracted and produced through the use of formers, fluxes, reductants, and stabilizers, at predetermined specified weight ratios. The base material utilized in this process is slag, typically derived from the mining industry. The slag is delivered and utilized in a manner that allows the adding and mixing of the various materials such as, but not limited to, carbon, calcium oxide, sodium oxide, aluminum oxide, magnesium oxide, and potassium oxide. The formulated mixture is then heated for a predetermined period of time, based upon weight to a liquid state, wherein the molten pig iron is separated from the molten silica glass. The molten pig iron is then poured into molds, and the molten silica glass is atomized into spherical proppant. The process is particularly well suited to slags produced from copper smelting, but can be extended to slags from other commodities and industries.

### CROSS-REFERENCE TO RELATED APPLICATIONS

This application claims the benefit of U.S. Provisional Application No. 62/259,545, filed Nov. 24, 2015, which application is hereby incorporated herein by reference, in its entirety.

### TECHNICAL FIELD

The invention relates generally to slags and, more particularly, to the conversion of copper smelting slag into two products: (1) atomized glass beads, namely, spherical silica-based proppant, and (2) a metal phase, namely, pig iron. Both products are produced from a feedstock of slag together with measured proportions of various additives and a method of making the same.

### BACKGROUND

Proppant

Proppants of various kinds are used in subterranean fractured oil and gas bearing wells, and are commonly combined in a fluid specially prepared for characteristics of geological formation, with adjusted viscosity, and are forced down a drilled oil or gas well, under pressure, the pressure being high enough to force the fracturing of the adjacent geological formations and then spread that fracture out into the surrounding geological formations. After fracturing of the oil or gas bearing formation, and upon release of the closure pressure, proppant particles remain behind in the fractures to brace the fractures open, increasing the flow of oil or gas out of the formation and into the well. Utilizing this process enhances the long term productivity of the oil and gas well.

Proppant materials vary from silica sand, resin coated silica sand, or engineered proppants such as aluminosilicates, and other alumina containing ceramics. Proppants are selected for use by various organizations based upon the needs of the geological formation, crush strength, chemical resistance, and price point. Proppants are categorized by their physical makeup, crush strength, and/or chemical resistance. Categorizing takes place under laboratory conditions utilizing tests such as Crush Strength and Conductivity-Permeability tests. Three common categories of proppants are the following:

1. Silica sands—Used in environments that do not exceed 5,000 psi.

2. Aluminosilicates (Lightweight Proppants)—Used in environments that range from 5,000-10,000 psi.

3. High Alumina Proppants—Used in environments that range from 15,000-20,000 psi.

For most organizations, the primary utilization consideration for proppants is cost. For example, about 125-250 tons of proppants are required for an average oil and gas well. All of the current engineered proppant materials now marketed are far more expensive than sands. This is due to raw material costs, processing costs, and production capabilities. Patents, such as U.S. Pat. Nos. 4,068,718, 4,427,068 and 4,522,731 teach these factors.

U.S. Pat. No. 4,555,493 teaches crushing and wet grinding processing steps.

U.S. Pat. Nos. 4,713,203 and 5,175,133 teach the use of a very fine particle fraction obtained from high grade bauxite ore as having the advantage of high reactivity and higher sintering rates. While high reactivity of fine ceramic oxides is well-known to aid sintering of alumina, the resulting compounds are also very expensive and usually reserved for the production of high grade technical ceramics. Almost all manufacturing processes for aluminosilicate and high alumina ceramic proppants employ a costly firing step by rotary furnace processing at sintering temperatures of 1300-14000° C. (2372-25520° F.) (U.S. Pat. No. 6,753,299).

Low-cost clay and bauxite raw materials are described in U.S. Pat. Nos. 6,753,299, 4,555,493 and 7,036,591. However, these approaches have the limitation of requiring that hydrated minerals such as kaolinite (Al₂Si₂O₅(OH)₄) and gibbsite (Al(OH)₃) as substitutes for calcined bauxite pay the energy penalty of water elimination during firing. Even if a proppant is derived from a spent aluminosilicate ceramic media, the crushing, grinding, and firing steps still must be performed, which can and does increase the full production costs.

Yet another approach (U.S. Pat. No. 5,175,133) teaches the use of a reinforced composite design, in which the aluminum metal is reinforced with ceramic microspheres. This approach has the drawback of high cost of metal additive as well as low chemical durability of common metals in high and low pH geological formation environments.

Techniques commonly employing very fine particulate high alumina clays and bauxite have been offered as requiring lower firing costs by making the raw material more reactive during firing, see, e.g., U.S. Pat. No. 5,175,133. However, fine particulate preparations such as fine grinding and wet milling necessarily dramatically increase the cost of raw materials substantially.

U.S. Patent Pub. No. 2005/0096207 A1 describes an approach for low temperature processing (about 200° C., or 392° F.) using the sol-gel technique for forming aluminosilicate and phosphate precursors and the use of waste material fillers. However, sol-gel precursors are themselves very expensive binding agents, and so the overall product cost is likely to be high.

U.S. Pat. No. 6,372,678 describes the use of spent catalysts, in which fluid cracking catalyst (FCC) petroleum refining catalyst is used as a source of aluminosilicate. This approach may have lower initial raw material sources; however, the process still requires crushing, grinding, agglomerating, and firing of proppant spheres. All of these processes add cost to the end product.

U.S. Pat. No. 4,607,697 describes forming proppant particles by blowing a stream of molten material from a base of zircon and silica. However, zircon is tremendously expensive, the price being driven by refractory use and the generally low commercial availability due to a controlled market.

U.S. Patent Pub. No. 2008/0087136 A1 to Ek describes a process for the thermal conversion of non-ferrous smelting slag to form granular products of sufficient strength and other characteristics by mixing with silica, alumina, calcia, and magnesia and then heating for a period of time sufficient for the reaction of the ingredients and homogenization for making into proppant, gravel pack, roofing granules, and abrasive blast materials. This approach produces a dense ferro-silicate as the only product and does not eliminate iron from the final product.

Pig Iron

Traditionally pig iron was worked into wrought iron in finery forges, later puddling furnaces, and more recently into steel. In these processes, pig iron is melted and a strong current of air is directed over it while it is stirred or agitated. This causes the dissolved impurities (such as silicon) to be thoroughly oxidized. An intermediate product of puddling is known as “refined pig iron” or simply “refined iron.”

Pig iron can also be used to produce gray iron. This is achieved by re-melting pig iron, often along with substantial quantities of steel and scrap iron, removing undesirable contaminants, adding alloys, and adjusting the carbon content. Some pig iron grades are suitable for producing ductile iron. These are high purity pig irons and, depending on the grade of ductile iron being produced, these pig irons may be low in elements of silicon, manganese, sulfur, and phosphorus. These types of pig irons are used to dilute all the elements in a ductile iron charge (except carbon) which may be harmful to the ductile iron process.

Some advantages of pig iron production include the following:

High Purity:
Quality assured
Lower detrimental residual elements
Free from extraneous materials
More useable iron per ton

Lower Ferro Alloy Additions:
Consistent chemical composition
Reduced additions of ferrosilicon, ferromanganese, coke, and recarburisers

Energy Savings:
High density charge
Lower coke usage in cupolas
Faster melting in induction furnaces
Lower melting point than steel

Reduce Storage Space:
Higher density reduces required storage space
Reduce handling and charging time

### SUMMARY

The present invention, accordingly, provides a low-cost process for making two products from the recycling of slag. These products are described as metal and glass, namely, (1) pig iron, for use in the foundry and steel industry, and (2) spherical glass beads for use as proppant in the oil and gas industry.

More specifically, for the production of the described products, slag is used as the base material. The slag is preferably processed cold with or without crushing and screening to provide a consistent particle size used in forming a consistent batch capable of melting in various commercial melting furnaces.

The present invention utilizes slag as the base material for producing metal and glass, namely pig iron and spherical silica-based proppant. The process is best suited if the slag comes from copper smelting, but can be extended to slags from other commodities and industries.

Through research and discovery it has been determined that when suitable fluxes and material additives are introduced during the mixing and melting process of the slag, in measured proportions, then proper chemical analysis for the pig iron is achieved, and the crush strength and chemical resistance of the spherical silica-based proppant are greatly enhanced.

Globally, slag that is and has been produced and that has not been altered either by chemical and/or heat has few end uses of any real value and, hence, little or no commercial value. Evidence of this can be found by analyzing the large slag piles located adjacent to both active and inactive smelter sites. Small amounts of slag derivatives containing iron are utilized as an iron oxide additive to Portland cement for the purpose of boosting iron silicate content or as a raw material for preparing abrasive blast material, road surface additives, and sanding material abrasives. These uses are more a consequence of an effort to remove or dispose of slag from a smelter location than a commercially significant recycling program capable of totally eliminating slag disposal on the land.

According to principles of the present invention, raw slag is dried, screened, and blended before entering a melting chamber. Once the melting process is started, molten slag is brought to a desired temperature range and the pig iron is channeled off. The remaining molten glass structure is super-heated to provide a desired viscosity for further production, in this case atomization into spherical silica-based proppant. It is this modified glass structure that becomes very useful after modification.

The blending additives may include, but are not limited to, low cost industrial mineral additives such as carbon, calcium oxide, sodium oxide, aluminum oxide, magnesium oxide, and potassium oxide, and the like.

Advantageously, the processes described herein greatly mitigate the need to crush and grind raw materials. Raw materials of a particle size measuring ⅜ inch and smaller can be used in the melting process. A further example provides a process where large tonnages of end product can be inexpensively made by utilizing the primary molten stream, taking it from the furnace environment via a delivery channel to pig iron molds and the atomization of the secondary molten stream of glass utilizing a spinning disc with rapid cooling to produce spherical silica-based beads.

Initial preparation of the slag, blending of materials and additives, provides for a consistent chemical makeup of the melt batches. This technique helps address the slight variations in the chemical structure of smelter slag, which helps to mitigate the disruption of the production process. Glass technology is well-proven for the ability to absorb chemical variation. End products may display variation in chemical composition, but important specifications of crushing strength and chemical durability are unaffected.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 depicts a schematic diagram of a continuous process embodying features of the present invention for converting raw slag and its additives into pig iron and silica-based proppant; and

FIG. 2 depicts a flow chart illustrating steps of a process employing the system of FIG. 1.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation.

Due to the number of different slag compositions, additives, scenarios, and other factors, certain specific numbers, amounts, flow rates, temperatures, times, and the like are not provided herein, but given any particular of compositions, additives, scenarios, and other factors it is believed that specific numbers, amounts, flow rates, temperatures, times, and the like could be readily determined by a person having ordinary skill in the art without undue experimentation.

Metal ores are found throughout the globe in impure states. When unearthed, these metals are usually mixed with other impurities. The smelting process is used to extract the metal from its ore origins and separate it from impurities. In most cases, this smelting process is carried out at temperatures higher than the melting point of the metal. Once in a molten bath, the impurities can be separated and removed from the molten metal based on differences in density and immiscibility. Once removed, these impurities are then categorized as “slag”. The process is used, for example, in copper smelters, iron blast furnaces, and steel recycling facilities. Slags rich in iron are referred to as ferrous slags, and those deficient in iron are referred to as non-ferrous slags.

More specifically, the smelting process is normally carried out in batch-operated converting furnaces where the molten metal sinks to the bottom and the molten slag floats on top. Slag is usually tapped from a smelter furnace at the end of each batch processing period. The slag stream is often water-quenched, the preferred practice, to form granules that can be easily handled after dewatering. A far less frequent practice is pouring of slag directly onto the ground to cool and harden.

Slag that has been rapidly cooled, as in quenching, displays an amorphous or glassy microstructure. Slag that has been cooled slowly exhibits a crystalline microstructure. Slag feed material of either amorphous or crystalline microstructure may be used interchangeably in the process described below.

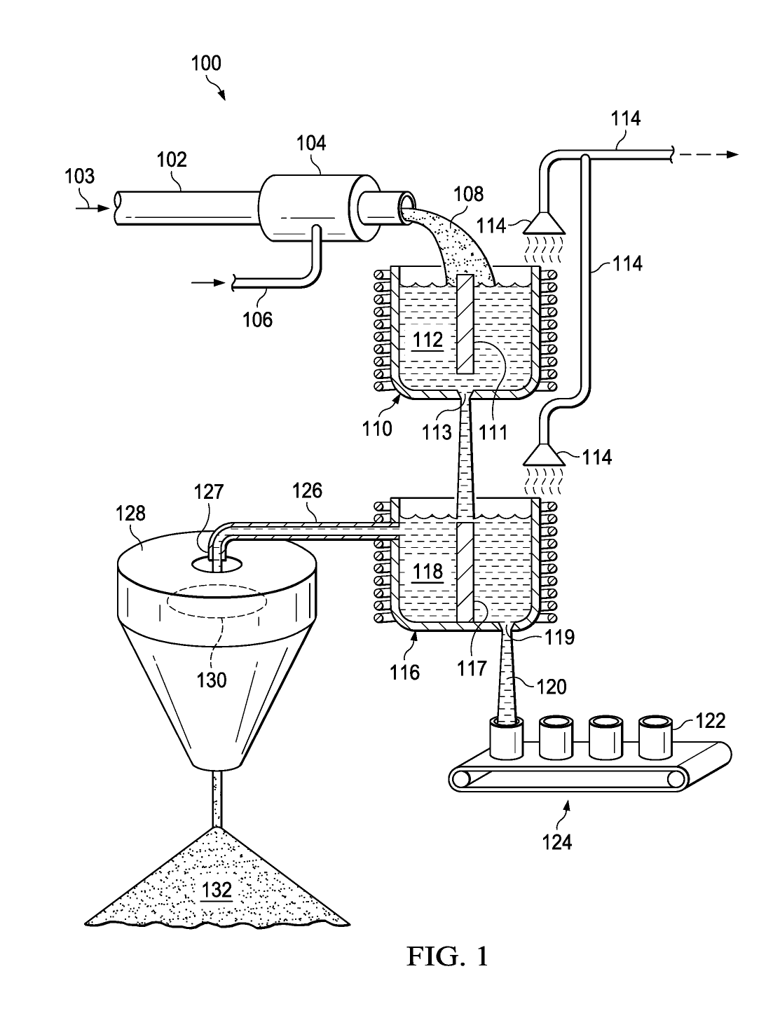

Referring to FIG. 1, the reference numeral 100 generally designates a system for converting raw slag and its additives into pig iron and silica-based proppant. Accordingly, a conduit 102 for receiving raw slag and additives in the direction of arrow 103 preferably passes through a preheater 104. In one preferred embodiment, preheater 104 is connected via a line 106 for receiving natural gas from a natural gas supply (not shown), but any source of energy may be used, as well known in the art. Conduit 102 is positioned for delivering its contents, raw slag and additives 108, into an initial melt furnace 110, which is preferably an induction furnace, effective for heating raw slag and additives 108 until it becomes a molten mixture 112. Furnace 110 preferably defines an opening 113 in the bottom thereof through which molten mixture 112 may pass to a separation furnace 116, which is also preferably an induction furnace. Separation furnace 116 is configured for heating the molten mixture 112 further until the molten mixture begins to separate into a separated mixture 118 comprising two layers: (1) an iron (“pig iron”) layer which sinks to the bottom of the melting chamber of the separation furnace, and (2) a glassy constituent (proppant) layer which rises to the top of the melting chamber of the separation furnace 116.

Furnaces 110 and 116 are preferably provided with susceptors 111 and 117, respectively, for enhancing the effectiveness of the induction heating. Still further, furnaces 110 and 116 are also preferably provided with heat recovery devices 114 configured for capturing heat from the furnaces and using it for other purposes, such as, by way of example, but not limitation, heating steam to run turbines to run electric generators (not shown).

Separation furnace 116 is provided with a conduit 126 for draining the upper layer of glassy constituent (proppant) to an atomization chamber 128 which channels the glassy constituent to a spinning disc 130, also known as a “rotating wheel”. Disc atomization chamber 128 preferably has an inverted conical shape, with a diameter at the top of about ten feet. Disc 130 preferably spins at a speed (e.g., about 3,000 RPM) optimized for atomizing the molten enhanced glass.

The bottom of furnace 116 defines an opening 119 through which the heavier iron (“pig iron”) layer 120 is drawn off to pig iron molds 122 preferably passing on a conveyer belt 124.

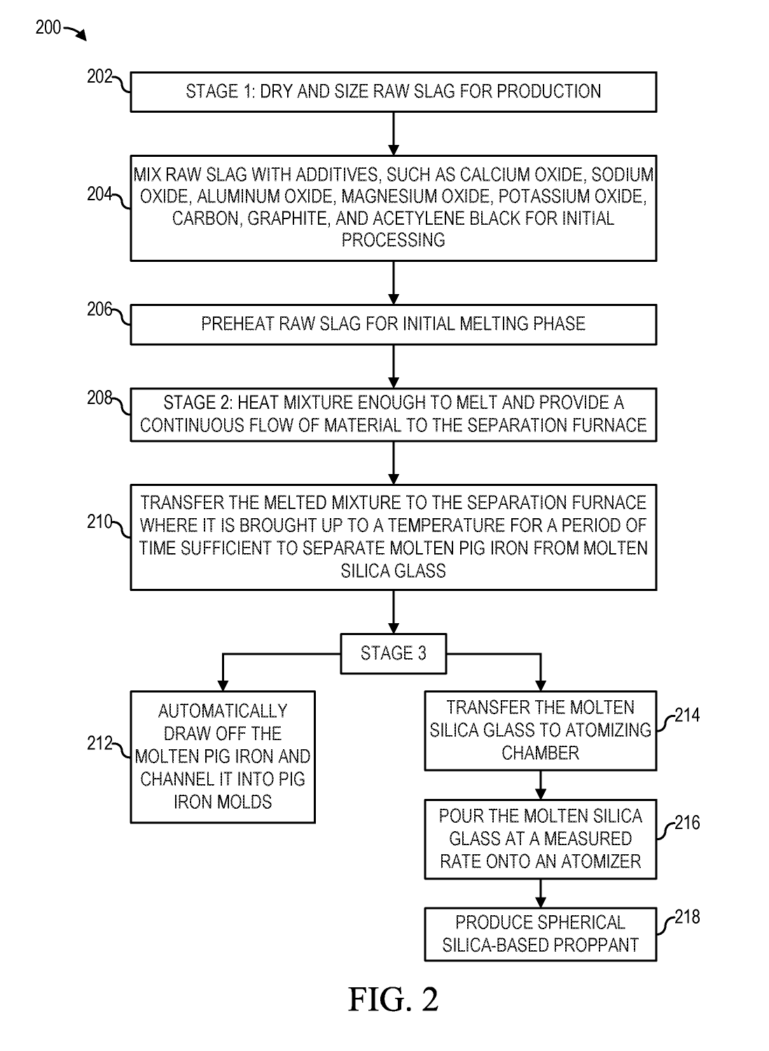

Referring to FIG. 2, the reference numeral 200 generally designates a sequence of steps for one preferred method performed according to the present invention for forming spherical silica-based proppant and pig iron from mining slag. The method for making the pig iron and silica-based proppant is set forth in a three-stage production process.

The first stage begins at step 202, wherein raw slag material is mitigated of outside agents being unknowingly introduced into the production process. This is accomplished preferably via a large capacity rotary dryer. This drying step is crucial due to the high explosive manner in which water reacts when introduced to extremely high-temperature environments.

Next the raw slag material is screened and sized for production. The widths (or lengths) of particles of raw slag are preferably set at about ⅜″ or smaller for optimized production melting efficiencies, though larger widths (or lengths) may be set as desired. The raw material is delivered to the screening plant preferably via belt conveyance. Raw material that meets the sizing requirements moves onto the next production stage. Material/particles exceeding about ⅜″ are sent to a vertical impactor for processing. Large particles are crushed so they may meet the measurement requirements. Once processed, crushed particles are sent back to the initial processing pile to be rescreened.

At step 204, raw slag material is delivered to a blending/mixing station (not shown) preferably via belt conveyance.

Various additives, such as, but not limited to, calcium oxide, sodium oxide, aluminum oxide, magnesium oxide, and potassium oxide, are introduced into the delivery stream of material entering the blending station in amounts measured based on the volume, weight, and elemental makeup of the raw slag material, that would be effective for limiting the variance in quality in both produced products, that is, in both the pig iron and the spherical silica-based proppant.

Carbon, graphite, acetylene black, and the like, are introduced into the stream in specified metered amounts, based on weight and volume effective for facilitating the separation in the molten material into two separate layers: (1) an iron (“pig iron”) layer which sinks to the bottom of the melting chamber of the separation furnace, and (2) a glassy constituent (proppant) layer which rises to the top of the melting chamber of the separation furnace.

The mixture then enters a large mixing cylinder (not shown) where the delivered material is blended together in a manner that more evenly distributes the various additives throughout the slag base material.

At step 206, the slag base material is delivered via conduit 102 to a preheat station 104 preferably via belt conveyance (not shown) where the temperature of the raw slag material is preferably raised to a level between about 700° F.-800° F., though lower or higher temperatures may be used as appropriate. The preheat step dramatically reduces the time spent in the melting phase of production.

The second stage begins at step 208, wherein the blended preheated mixture is delivered to initial melt furnace 110 which heats the mixture at least until it begins to melt. The initial melt furnace 110 is preferably an induction furnace utilizing a susceptor 111 and is positioned in a manner to deliver molten material directly into the main melt chamber of separation furnace 116. Initial melt furnace 110 preferably receives a continuous flow of the preheated mixture to allow the constant continual delivery of molten material to separation furnace 116.

At step 210, the molten material is transferred to main melting chamber of separation furnace 116, where the temperature of the molten mixture is preferably raised beyond the melting point to a temperature (e.g., within the range of approximately 2200° F.-3000° F.) and for a period of time sufficient to separate the molten material into two separate layers: an iron (“pig iron”) layer which sinks to the bottom of the melting chamber, and a glassy constituent (proppant) layer which rises to the top of the melting chamber. The process as described herein enhances the conversion of the molten stream into two products with superior qualities, namely, (1) pig iron and (2) spherical silica-based proppant that preferably meets or exceeds upper specification levels, as outlined by ISO and API of Crush Strength (7,000-15,000 lbs psi), Sphericity (Y 0.9/X 0.9 Krumbein's Chart∥≧0.9 API), Roundness (≧0.9 API), Conductivity, and Chemical Resistance, wherein, according to the ISO standards, namely (ISO) 13503-2, “Sphericity is a measure of how close a proppant particle approaches the shape of a sphere. Roundness is a measure of the relative sharpness of corners or of curvature.”

Steps 212-218 constitute the third and final stage of the process. Accordingly, at step 212, once the molten mixture has separated into layers, the pig iron is directed to pig iron molds. The temperature of the remaining molten glass is optionally raised to a temperature (e.g., within the range of approximately 2750° F.-3300° F.) and for a period of time sufficient to reduce the viscosity of the molten glass for proper atomization.

At step 214, the adjusted molten glass is preferably transferred via heated channels to disc atomizing chamber 128. This step allows the molten glass to be metered at a flow rate and controlled at a temperature optimized for atomization.

At step 216, disc atomization is preferably achieved by channeling the molten enhanced glass onto spinning disc 130 in a disc atomization chamber 128.

At step 218, once the molten glass strikes spinning disc 130, it is flung off the edge of the disc into the air allowing it to form into spherical beads. The beads travel about half the diameter of chamber 128 (e.g., about five feet) in the air and then hit the edge of a catch basin, such as a large conical shaped catch basin having substantially the diameter of atomization chamber 128 at the top and conically-shaped downwardly so that solidified beads can funnel downwardly and be easily collected, for example, in a pile 132.

Precise calculations are preferred to achieve optimal quality output and product field performance. These calculations account for the distance (or the “strike” distance) between the channeling spout 127 and the atomizing disc, the size of the disc, the rate at which the disc spins, the distance in which the molten beads travel after coming into contact with the disc, the cooling temperature, and the cooling method used. These calculations and measurements provide the quality and sizing of proppant that are required in the marketplace. Due to the number of different slag compositions, additives, scenarios, factors, and the like, specific numbers are not provided herein, but it is believed that they could be readily determined by a person having ordinary skill in the art without undue experimentation.

Due to the low cost of the slag, the pig iron and spherical silica-based proppant can be commercially offered for sale at a lower or similar price structure than lower quality and lower performing proppants and pig iron on the market today.

An efficient melting furnace operated as an all-electric, fossil fuel fired, or alternatively a furnace that uses electric melting and fossil fuel top firing, can be used. An all-electric furnace is preferred.

Pig iron ingot casting can utilize forms on a conveyer that run directly underneath the furnaces that are in-line with the evacuation channel—a standard methodology utilized in this case.

Proppant forming techniques involve atomization processes which are efficient and hence inexpensive to operate because the molten stream for proppant development is provided by the same furnace utilized in the melting and development of the pig iron.

Additionally, zinc oxide may be gathered and processed as a byproduct of the melting process. The production and management of the zinc oxide are preferably arranged and managed adjacent to the atomization process.

The presence of typical contaminant compounds contained in slag is not generally detrimental to the end product manufacture or specification. For example, smelter slags that are targeted and analyzed for production normally contain small amounts of copper, lead, zinc, cadmium, chromium, sulfur, tellurium, zirconium, arsenic, cobalt, manganese, antimony, nickel, tin, strontium, barium, titanium, germanium, fluorine, chlorine, potassium, sodium, and/or others. Minor contaminants must be controlled in the pig iron product, namely phosphate and sulfur, as shown by way of example, but not limitation, in the Table below. However, minor contaminants are not detrimental to the glass product. Glass systems have been abundantly shown to be capable of accommodating minor ingredient contaminants without detriment, as is well-known in glass technology.

The present invention provides a silica-based glass that has been shown to produce a commercially viable product. The formulation has incorporated into it, by design, sufficient glass formers, fluxes, and modifiers to absorb slag chemistry variation.

TABLE
Chemical Analysis of Typical Pig Iron (in weight-percents)

| C—Carbon | Si—Silicon | Mn—Manganese | | | |
|---|---|---|---|---|---|
| (min-max) | (min-max) | (min-max) | S—Sulfur | P—Phosphorus | Fe—Iron |
| 3.5-4.5 | 1.5-3.5 | 0.5-1.0 | 0.05 max | 0.15 max | Balance |

Variable slag chemistries can be processed by balancing the additive ingredients, such as carbon, calcium oxide, sodium oxide, aluminum oxide, magnesium oxide, and potassium oxide.

The additives for the proposed production of pig iron and spherical silica-based proppant may be purchased as raw material, which is readily available as granular or powdered products. For example, raw material in mesh sizes of ⅜″ and smaller have been found to be beneficial. Smaller particle sizes are preferred and will be sought out for the advantages of higher reactivity than the larger sizes. This higher reactivity provides lower energy input as well as shorter processing times.

It is understood that the present invention may take many forms and embodiments. Accordingly, several variations may be made in the foregoing without departing from the spirit or the scope of the invention. For example, the process of the invention may be performed as a batch process in a manner that would be apparent to a person having ordinary skill in the art based upon a reading of the present disclosure.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claim be construed broadly and in a manner consistent with the scope of the invention.

1. A system for forming spherical silica-based proppant and pig iron from mining slag, the system comprising:
a conduit for conveying slag;
a first furnace positioned for receiving the slag from the conduit, the first furnace defining a first opening in the bottom thereof;
a second furnace positioned for receiving material from the first opening, the second furnace defining a second opening in the bottom thereof;
at least one mold positioned to receive material passing through the second opening; and
a conduit for passing material in an upper portion of the second furnace to an atomization chamber having a spinning disc.

2. A method for forming spherical silica-based proppant and pig iron from mining slag, the method comprising:
forming a slag mixture by adding and mixing into slag at least one of carbon, calcium oxide, sodium oxide, aluminum oxide, magnesium oxide, and potassium oxide;
heating the slag mixture to a liquid state, wherein the molten pig iron is separated from the molten silica glass;
pouring molten pig iron into molds; and
atomizing molten silica glass into spherical proppant.
